(19) United States
(12) Patent Application Publication
(10) Pub. No.: US 2021/0335016 A1
(43) Pub. Date: Oct. 28, 2021

(54) METHOD AND DEVICE FOR ENCODING OR DECODING THREE-DIMENSIONAL DATA POINT SET

(71) Applicant: SZ DJI TECHNOLOGY CO., LTD., Shenzhen (CN)

(72) Inventors: Pu LI, Shenzhen (CN); Xiaozhen ZHENG, Shenzhen (CN)

(21) Appl. No.: 17/372,042

(22) Filed: Jul. 9, 2021

Related U.S. Application Data
(63) Continuation of application No. PCT/CN2019/071238, filed on Jan. 10, 2019.

(51) Int. Cl. G06T 9/00; G06T 9/40

(52) U.S. Cl. CPC G06T 9/001; G06T 9/40

(57) ABSTRACT

The present disclosure provides a three-dimensional (3D) data point set encoding method. The method includes performing position coordinate encoding on position coordinates of one or more 3D data points in the 3D data point set to obtain a first binary bitstream; performing binary encoding on attributes of the one or more 3D data points based on a position coordinates sequence after encoding the position coordinates of the one or more 3D data points to obtain a second binary bitstream; and performing entropy encoding on the first binary bitstream and the second binary bitstream respectively.

### CROSS-REFERENCE TO RELATED APPLICATIONS

This application is a continuation of International Application No. PCT/CN2019/071238, filed on Jan. 10, 2019, the entire content of which is incorporated herein by reference.

### TECHNICAL FIELD

The present disclosure relates to the technical field of information processing and, more specifically, to a method and device for encoding or decoding a three-dimensional (3D) data point set.

### BACKGROUND

A 3D data point set is a form of expression of a 3D object or scene, which is composed of a set of discrete points that are randomly distributed in space and express the spatial structure and surface properties of the 3D object or scene. The data of a 3D data point set may include 3D coordinates describing coordinate information, and further include attributes of the position coordinates. To accurately reflect the information in the space, the number of discrete points required is huge. Therefore, in order to reduce the bandwidth occupied by the data storage and transmission of the 3D data point set, the 3D data point set needs to be encoded and compressed. In the process of encoding and compressing the 3D data point set, the encoding of position coordinates is generally carried out separately from the encoding of attributes. When encoding attributes, a layered encoding method can be used.

However, a hierarchical structure needs to be built for this encoding method, and all 3D data points need to be traversed multiple times when selecting adjacent reference points for the position of each 3D data point set. This encoding method takes a long time to complete during encoding and decoding, especially when the amount of data in the 3D data point set is large, the time and complexity of this method is particular high. In addition, the header information related to the attribute in the coded bitstream needs to describe the relevant information about the attribute of the layered encoding. When the number of 3D data points is relatively small, this information will account for a relatively large portion of the compressed bitstream, which becomes a bottleneck restricting the compression rate.

### SUMMARY

One aspect of the present disclosure provides a three-dimensional (3D) data point set encoding method. The method includes performing position coordinate encoding on position coordinates of one or more 3D data points in the 3D data point set to obtain a first binary bitstream; performing binary encoding on attributes of the one or more 3D data points based on a position coordinates sequence after encoding the position coordinates of the one or more 3D data points to obtain a second binary bitstream; and performing entropy encoding on the first binary bitstream and the second binary bitstream respectively.

Another aspect of the present disclosure provides a 3D data point set decoding method. The method includes performing entropy decoding on a to-be-decoded bitstream of the 3D data point set to obtain a first binary bitstream and a second binary bitstream; performing position coordinate decoding on the first binary bitstream to obtain position coordinates of one or more 3D data points in the 3D data point set; and performing binary decoding on the second binary bitstream based on a decoded position coordinates sequence of the one or more 3D data points to obtain attributes of the one or more 3D data points.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a block diagram of a 3D data point set encoding method according to an embodiment of the present disclosure.

FIG. 2 is a block diagram of the 3D data point set encoding method according to another embodiment of the present disclosure.

FIG. 3 is a block diagram of a 3D data point set decoding method according to an embodiment of the present disclosure.

FIG. 4 is a block diagram of the 3D data point set decoding method according to another embodiment of the present disclosure.

FIG. 5 is a schematic diagram of a hierarchical structure of a level of detail (LOD) coding scheme.

FIG. 6 is a block diagram of the 3D data point set encoding method according to an embodiment of the present disclosure.

FIG. 7 is a block diagram of the 3D data point set decoding method according to an embodiment of the present disclosure.

FIG. 8 is a block diagram the 3D data point set encoding method according to another embodiment of the present disclosure.

FIG. 9 is a block diagram the 3D data point set decoding method according to another embodiment of the present disclosure.

FIG. 10 is a block diagram the 3D data point set encoding method according to another embodiment of the present disclosure.

FIG. 11 is a block diagram the 3D data point set decoding method according to another embodiment of the present disclosure.

FIG. 12 is a block diagram the 3D data point set encoding method according to another embodiment of the present disclosure.

FIG. 13 is a block diagram the 3D data point set decoding method according to another embodiment of the present disclosure.

FIG. 14 is a schematic diagram of a cubit octree division according to an embodiment of the present disclosure.

FIG. 15 is a schematic diagram of an octree encoding method according to an embodiment of the present disclosure.

FIG. 16 is a schematic diagram of a distance measuring device according to an embodiment of the present disclosure.

FIG. 17 is a schematic diagram of the distance measuring device according to an embodiment of the present disclosure.

FIG. 18 is a schematic diagram of a scanning pattern according to an embodiment of the present disclosure.

FIG. 19 is a block diagram of a 3D data point set encoding device according to an embodiment of the present disclosure.

FIG. 20 is a block diagram of the 3D data point set encoding device according to an embodiment of the present disclosure.

FIG. 21 is a schematic diagram of a computer system according to an embodiment of the present disclosure.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

Unless otherwise defined, all the technical and scientific terms used in the present disclosure have the same or similar meanings as generally understood by one of ordinary skill in the art. As described in the present disclosure, the terms used in the specification of the present disclosure are intended to describe example embodiments, instead of limiting the present disclosure.

The 3D data point set can be composed of discrete 3D data points. The data of each 3D data pint may include information describing the position coordinates of the 3D data point, and may further include attribute information. In some embodiments, the position coordinates of the 3D data points can be 3D position coordinates (x, y, z). The attribute of the 3D data points can include reflectance and/or color of the 3D data points.

The 3D data point set described in the embodiments of the present disclosure may be a point cloud, and correspondingly, the 3D data point may be a point cloud point. The 3D data point set described in the embodiments of the present disclosure can be used for high-precision 3D maps.

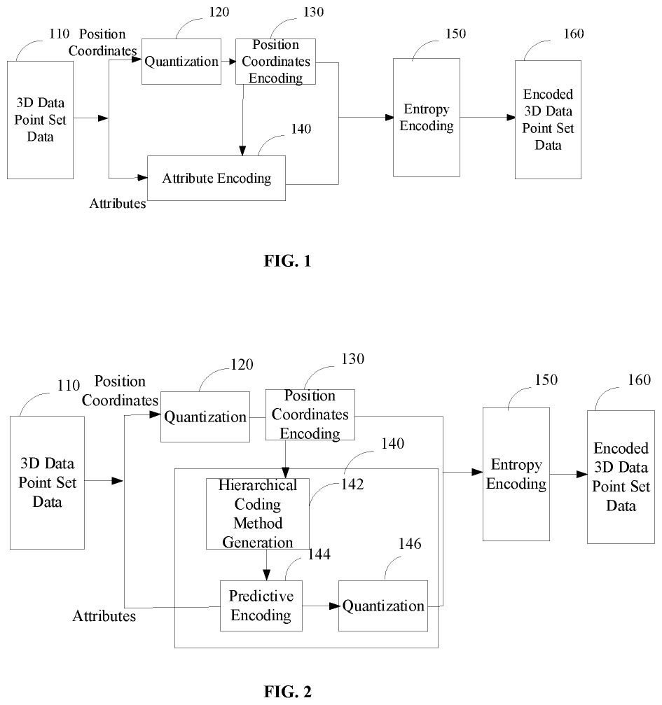

In order to accurately reflect spatial information, the number of 3D data points included in the 3D data point set is generally relatively large. To reduce the bandwidth occupied by the storage and transmission of the 3D data point set, the data of the 3D data point set needs to be encoded and compressed. The encoding and decoding of a 3D data point set will be described below in conjunction with FIG. 1 and FIG. 2.

In the encoding method shown in FIG. 1 and FIG. 2, in the process at 110, the data of the 3D data point set is input into an encoder, and in the process at 120, the position coordinates in the data of the 3D data point set are quantified. In the process at 130, the quantized position coordinates are encoded. In the process at 140, the attributes in the data of the 3D data point set are encoded in the order of the position coordinates after the position coordinate encoding. In the process at 150, entropy encoding is performed on a bitstream obtained after encoding the position coordinates and a bitstream obtained after attribute encoding. In the process at 160, the data of the encoded 3D data point set can be output, for example, it can be output to a memory for storage, or it can be transmitted to decoding end.

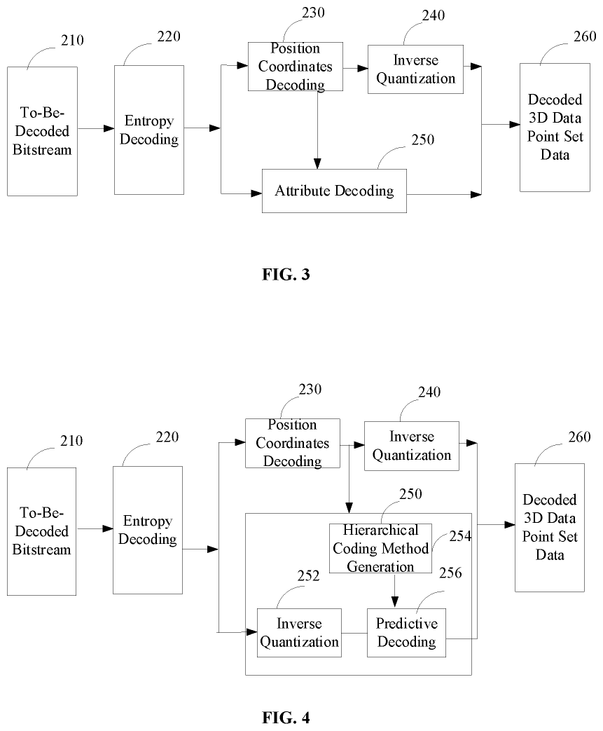

In the decoding method shown in FIG. 3 and FIG. 4, in the process at 210, a to-be-decoded bitstream of the 3D data point set data is obtained. For example, the bitstream can be obtained from the memory, or the bitstream transmitted by the encoding end can be obtained. In the process at 220, entropy decoding is performed on the bitstream, and the bitstream corresponding to the position coordinates and the bitstream corresponding to the attribute can be obtained. In the process at 230, position coordinates decoding is performed on the bitstream corresponding to the position coordinates. In the process at 240, inverse quantization is performed on the decoded position coordinates. In the process at 250, the attributes are decoded in the order of the decoded position coordinates. In the process at 260, the data of the decoded 3D data point set is obtained based on the decoded attributes and position coordinates.

As shown in FIG. 2, in the process at 140, the encoding operations on attributes can include processes 142, 144, and 146. In the process at 142, based on the position coordinates encoded by the position coordinates, a level of detail (LOD) can be generated. In the process at 144, predictive encoding can be performed based on the hierarchical encoding method. In the process at 146, the result of the predictive encoding can be quantized.

As shown in FIG. 4, in the process at 250, the encoding operations on attributes can include processes 252, 254, and 256. In the process at 252, inverse quantization on the decoded attribute bitstream can be performed. In the process 254, a hierarchical decoding method based on the position coordinates after decoding the position coordinates can be generated. In the process at 256, predictive decoding can be performed based on the hierarchical coding method.

In the actual encoding process, LOD layering can be performed based on the parameters of the LOD configuration, where the latter layer may include the points of the previous layer. For example, as shown in FIG. 5, in LOD0 (layer 0), the 3D data points included are P0, P5, P4, and P2. In the LOD1 (layer 1), the 3D data points included are P0, P5, P4, P2, P1, P6, and P3. In the LOD2 (layer 2), the 3D data points included are P0, P5, P4, P2, P1, P6, P3, P9, P8, and P7.

In a layering example, a first 3D data point in the 3D data point set can be first selected, and the first 3D data point can be placed at the first point of the LOD0 layer. Then the 3D data points can be sequentially traversed, and the distances in the Cartesian coordinate system between this point and all the points already included in the current layer can be calculated. If the minimum distance is greater than a distance threshold (dist2) set in the current LOD layer, this point will be categorized to the current LOD layer. In addition, in this process, the calculated distances can be sorted, and several shortest distances can be selected. This number can be determined by the number of neighbors during prediction (numberOfNeighborsInPrediction) N. In some embodiments, after a 3D data point is divided into a LOD layer, there may be no need to determine whether it belongs to the next LOD layer in the future. This is because the next layer includes the previous layer, therefore, the 3D data point must belong to the next LOD layer and a few points of the LOD0 layer. Since the number of points in the LOD may be relatively low, the number of selected reference points may be less than the number N.

After the LOD layer is divided, the nearest point previously selected can be used to assign weights for prediction. For example, for each 3D data point, after obtaining the nearest N points sorted by distance, the weight distribution method can be calculated based on one reference point, two reference points, and up to N reference points. There are N types of weigh distribution methods. When there is one reference point, the reference point may be the point with the shortest distance, and its weight may be one. When there are two reference points, the two points with the shortest distances can be selected as the reference points. At this time, the weight can be assigned based on the distance between the two reference points and the point to be predicted. The specific weight may be inversely proportional to the distance, the farther the distance, the smaller the weight, and the sum of the weight to be ensured to be one. When there are N reference points, N reference points can be selected, and the weight distribution method may be the same as above.

After assigning weights, the number of reference points can be selected. It should be noted that the number of adjacent reference points that can be selected for a prediction point may be less than or equal to N. More specifically, when the maximum number of reference points is limited to one, at this time the quantified value of the residuals between the predicted value (weight multiplied by the attribute value of the corresponding position) and the actual attribute value may be the sum of the values. This sum may be the cost when the number of reference point is at most one. Then the cost when the maximum number of reference point is limited to two can be traversed until the cost when the maximum number of reference points is limited to N, and a solution with the smallest cost and maximum number of reference points can be selected at the end. Subsequently, the quantized residual value can be encoded using this solution.

However, this encoding method needs to traverse all 3D data points multiple times when constructing a hierarchical structure and selecting adjacent reference points for each 3D data point. This encoding method takes a long time to complete during encoding and decoding, especially when the amount of data in the 3D data point set is large, the time and complexity of this method is particular high.

In addition, the header information related to the attributes in the encoded bitstream needs to describe the relevant information about the layered encoding attributes, that is, the LOD. More specifically, when making prediction at each layer, the number of points (numberOfNeighborsInPrediction) adjacent to the reference point (the position coordinates used to calculate the residual), the number of LOD levels (levelOfDetailCount), the distance threshold for dividing each layer of the LOD (dist2), the quantization step size of each layer of the LOD (quantizationSteps), and the size of the dead zone of each layer of the LOD (quantizedDeadZoneSize) (that is, the residual interval to quantized the residual to 0) can be selected. In some embodiments, the last three attributes can be set for each layer of LOD, and the attributes of each layer can be written into the bitstream header information. When the number of 3D data points is relatively small, the proportion of compressed bitstream will be relatively large, which becomes a bottleneck restricting the compression rate.

In view of the above, embodiments of the present disclosure provide the following technical solutions, which can simplify the encoding and decoding method to reduce the time overhead of encoding and decoding, and can increase the compression rate.

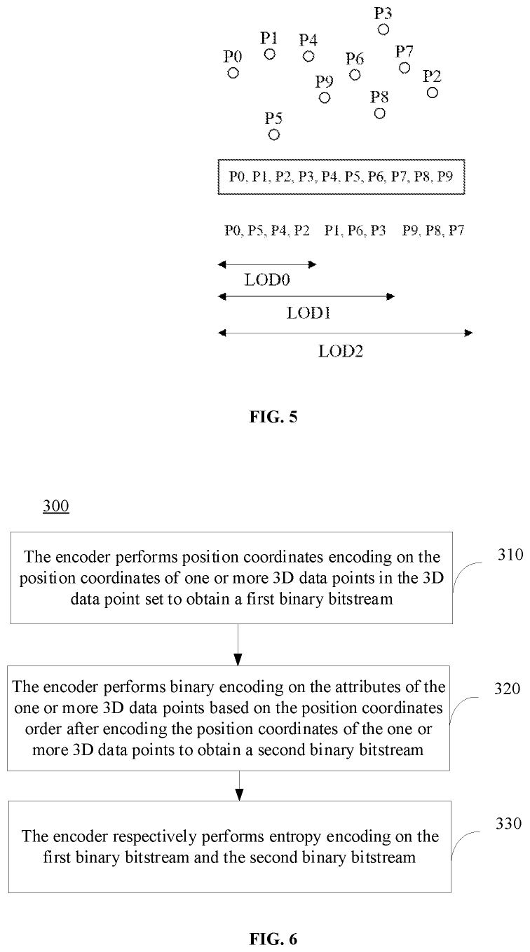

FIG. 6 is a flowchart of a method 300 for encoding a 3D data point set according to an embodiment of the present disclosure. The method can be implemented by an encoder. The method will be described in detail below.

310, the encoder performs position coordinates encoding on the position coordinates of one or more 3D data points in the 3D data point set to obtain a first binary bitstream.

320, the encoder performs binary encoding on the attributes of the one or more 3D data points based on the position coordinates order after encoding the position coordinates of the one or more 3D data points to obtain a second binary bitstream.

330, the encoder respectively performs entropy encoding on the first binary bitstream and the second binary bitstream, the entropy encoding may be arithmetic encoding. Further, the encoder may store or transmit the entropy-encoded bitstream to a decoding end.

Correspondingly, an embodiment of the present disclosure provides a method 400 for decoding a 3D data point set. The method can be implemented by a decoder. The method will be described in detail below.

410, the decoder performs entropy decoding on the to-be-decoded bitstream of the 3D data point set to obtain the first binary bitstream and the second binary bitstream. In some embodiments, the to-be-decoded bitstream may be transmitted to the decoder by the encoding end, or read from the memory by the decoder.

420, the decoder decodes the position coordinates of the first binary bitstream to obtain the position coordinates of one or more 3D data points in the 3D data point set.

430, the decoder performs binary decoding on the second binary bitstream to obtain the attributes of the one or more 3D data points based on the decoded position coordinates.

Consistent with the present disclosure, the attributes of one or more 3D data points in the 3D data point set can be binary-encoded, which can avoid the higher encoding complexity caused by layered encoding, thereby simplifying the encoding method and reducing the time overhead of encoding and decoding. In addition, the binary encoding method does not need to add more encoding information to the bitstream, such that the compression rate can be improved.

The 3D data point set in the embodiments of the present disclosure may be obtained by optical detection (e.g., laser detection) of an object to be detected by an optical detection device. The optical detection device may be a photoelectric radar or a lidar. The encoder in the embodiments of the present disclosure can be integrated into the optical detection device.

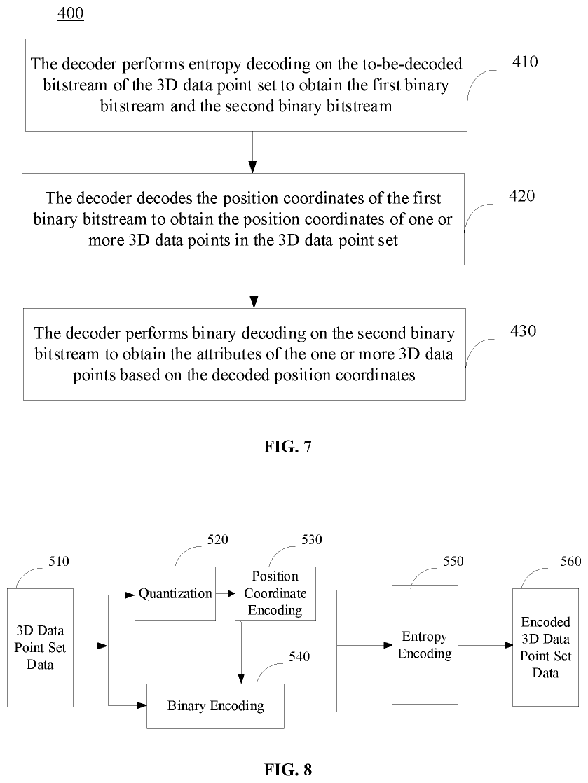

It should be understood that the encoding method shown in FIG. 6 and FIG. 7 may be part of the processes of the encoding and decoding process, and the encoding and decoding process the embodiments of the present disclosure may also include other processes.

As shown in FIG. 8 to FIG. 10, before encoding the position coordinates, the position coordinates can also be quantified. More specifically, in the process at 510, the data of the 3D data point set is input into the encoder. In the process at 520, the position coordinates in the data of the 3D data point set are quantified. In the process at 530, position coordinates encoding is performed on the quantized position coordinates. In the process at 540, the attributes in the data of the 3D data point set are binarized based on the order of the position coordinates after the position coordinates encoding. In the process at 550, entropy encoding is performed on the bitstream obtained after position coordinates encoding and the bitstream obtained after attribute encoding. In the process at 560, the data of the encoded 3D data point set is output, for example, it can be output to the memory for storage, or it can be transmitted to the decoding end.

In addition, as shown in FIG. 11, after the position coordinates are decoded, the decoded position coordinates can also be inversely quantized. In the process at 610, the to-be-decoded bitstream of the data of the 3D data point set is obtained, for example, the bitstream can be obtained from the memory, or the bitstream transmitted by the encoding end can be obtained. In the process at 620, entropy decoding is performed on the bitstream to obtain the bitstream corresponding to the position coordinates and the bitstream corresponding to the attributes. In the process at 630, position coordinates decoding is performed on the bitstream corresponding to the position coordinates. In the process at 640, inverse quantization is performed on the decoded position coordinates. In the process at 650, binary decoding can be performed on the attributes based on the order of the decoded position coordinates. In the process at 660, the data of the decoded 3D data point set is obtained based on the decoded attributes and position coordinates.

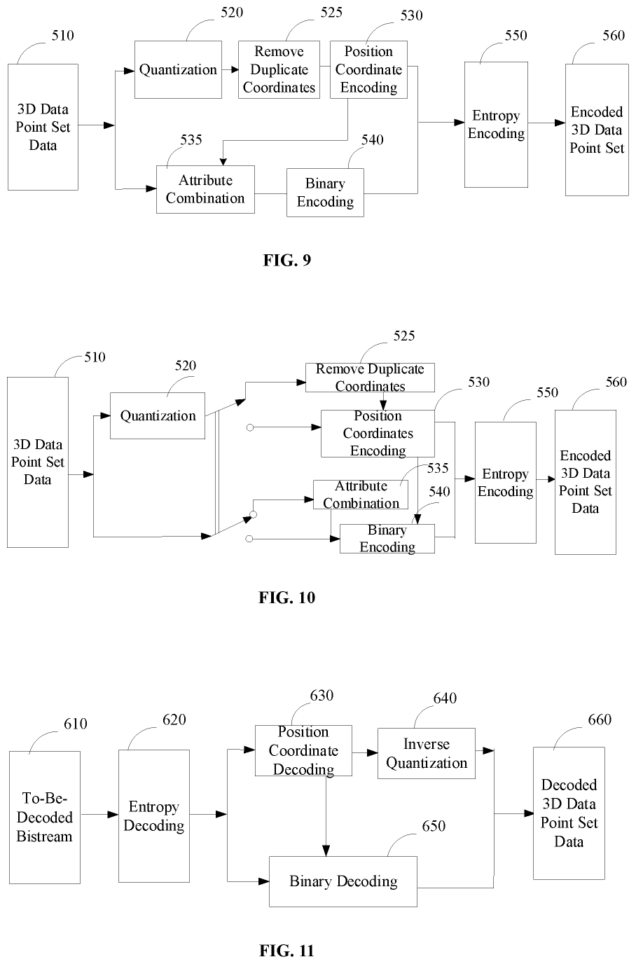

In some embodiments, after the encoder quantizes the position coordinates, the quantized position coordinates of at least two position coordinates may be the same, and these at least two position coordinates may correspond to at least two attribute values. At this time, before encoding the quantized position coordinates, the duplicate coordinates can be removed (e.g., the process at 525 as shown in FIG. 9). That is, the quantized position coordinates of the at least two position coordinates can be one (e.g., it can be referred to as the first position coordinates). Correspondingly, the at least two attribute values can be combined (e.g., the process at 535 shown in FIG. 9) to obtain one value, for example, the weighted combination can be performed. For the at least two position coordinates during decoding, the decoding end may decode a position coordinate and an attribute value.

Of course, in the embodiments of the present disclosure, even if the quantized position coordinates of at least two position coordinates are the same, it may not be needed to remove the duplicate coordinates and combine the at least two attribute values. At this time, a quantized position coordinates may correspond to at least two attribute value. When the decoding end performs decoding, at least two attribute values can be decoded for the quantized position coordinates, such that at least two 3D data points can be obtained.

In some embodiments, since different quantized position coordinates may correspond to different numbers of attribute values, the number of corresponding attribute values can be written in the bitstream for each quantized position coordinates. In this way, the decoder can determine the number of attributes corresponding to each position coordinates based on the information carried in the bitstream. In addition, the bitstream of the attribute may be continuous, each attributed may be decoded in sequence, and the corresponding position coordinates and attributes may be realized by corresponding to the order of the 3D data points.

Of course, in some embodiments, only the special quantized position coordinates (e.g., the number of corresponding attribute values may be more than one) may be marked

In some embodiments, whether the encoder removes duplicate coordinates and combines attributes can be preset on the encoder. For example, some encoders may be preset to remove duplicate coordinates and perform attribute combination, and some encoders may be preset to not remove duplicate coordinates and perform attribute combination.

Alternatively, whether the encoder removes duplicate coordinates and combines attributes can also be selected by the encoder. In some embodiments, the encoder may determine whether to remove duplicate coordinates and combine attributes based on the current encoding conditions. For example, as shown in FIG. 10, after quantization in the process at 520, the position coordinates can be directly encoded in the process at 530, and not to combine the attributes in the process at 535, but directly encode the attributes in the process at 540. Alternatively, after the quantization in the process at 520, the encoder may choose to remove the duplicate coordinates in the process at 525, encode the position coordinates in the process at 530, combine the attributes in the process at 535, and encode the attributes in the process at 540.

More specifically, if the current encoding loss is directed to be as low as possible or the compression rate is not high, then the duplicate coordinate removal and attribute combination may not be performed, otherwise, the duplicate coordinate removal and attribute combination may be performed.

In some embodiments, the 3D data points can be encoded based on packages, and correspondingly, at the decoding end, the 3D data points can be decoded based on packages.

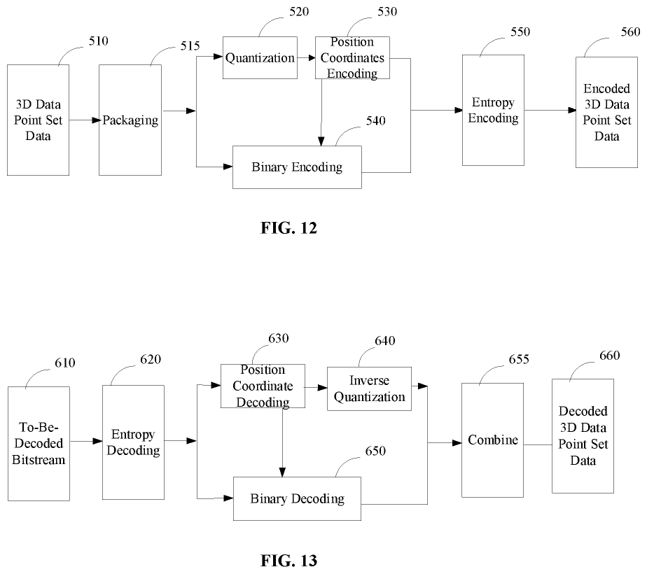

For example, as shown in FIG. 12, after obtain the data of the 3D data point set, the 3D data points can be packaged in the process at 515. Correspondingly, as shown in FIG. 13, at the decoding end, after decoding the 3D data points in each 3D data point set package, each package can be combined to obtain the data of the reconstructed 3D data point set.

In some embodiments, when the encoding end packages 3D data points, if the number of 3D data points transmitted reaches a preset value, a 3D data point package can be determined as obtained, and the 3D data point set in the 3D data point package can be encoded. The number of 3D data points included in the 3D data point set package may be determined based on the processing capability and compression rate requirements of the encoding end, or may be determined based on other factors, which is not limited in the embodiments of the present disclosure.

Therefore, in the embodiments of the present disclosure, the 3D data pints can be processed based on the 3D data point set package, such that the number of 3D data points process each time may not exceed a certain number. In this case, if a layered encoding method is used, the relevant information about the layered encoding attributes, that is, the LOD, may occupy a relatively large proportion, which will result in a lower compression rate. However, if binary encoding is performed on the attributes, this situation can be avoided and the compression rate can be improved.

The attributes in the embodiments of the present disclosure may be an attribute with one component, for example, the attribute may be reflectance.

Since the attribute with one component occupies less information bits, the binary encoding method for this type of attribute can be used to avoid compression loss and avoid the compressed bitstream from occupying too much transmission bandwidth or storage space. Of course, the attribute in the embodiments of the present disclosure may also have more than one component, which is not limited in the embodiments of the present disclosure.

in the embodiments of the present disclosure, the binary bitstream can be obtained after the binary encoding. In some embodiments, the character string before the binary encoding can be binary or non-binary. For example, the character string can be a decimal or octal character string.

Correspondingly, the object of binary decoding can be a binary bitstream, and the character string obtained by binary decoding can be a binary character string or a non-binary character string. For example, character string can be a decimal or octal character string.

The encoding method of the binary encoding in the embodiments of the present disclosure may be a fixed-length code encoding method, a truncated Rice encoding method, or a K-order exponential Golomb encoding method. Correspondingly, the decoding method of the binary decoding may be a fixed-length code decoding method, a truncated Rice decoding method, or a K-order exponential Golomb decoding method.

In order to understand the present disclosure more clearly, the encoding method and the corresponding decoding method of binary encoding will be described in detail below.

A fixed-length code encoding method may refer to a conversion of the attributes corresponding to the position coordinates of each 3D data point in the 3D data point set into a binary value. The number of codes occupied by this value is fixed, that is, the converted value may be referred to as a fixed-length code. In some embodiments, the depth of the fixed-length code may be fixed. When performing fixed-length code encoding, the depth of the fixed-length code may be written into the bitstream. More specifically, the depth of the fixed-length code may be written into the header information of the bitstream. In this way, the decoding end can obtain the depth of the fixed-length code from the header information of the bitstream, and obtain the attributes corresponding to each position coordinates based on the depth of the fixed-length code.

Alternatively, the depth of the fixed-length code may be known to the encoder and decoder. For example, the depth of the fixed-length code may be preset at the encoding end and the decoding end respectively. In this case, there may be no need to write the depth of the fixed-length code in the bitstream.

The depth of the fixed-length code may be changed to a certain extent. For example, each 3D data point set package may correspond to a fixed-length bit depth, and the depth of the fixed-length code corresponding to different 3D data point set packages may be different. In the process of encoding the fixed-length code of the 3D data points in a certain 3D data point set package, the fixed-length code of the depth corresponding to the 3D data point set package may be used for binary encoding, and the depth may be written into the header information of the bitstream corresponding to the 3D data point set package. Correspondingly, when the decoding end decodes each 3D data point set package, the depth of the fixed-length code corresponding to the 3D data point set package may be obtained from the header information of the 3D data point set package. Based on the depth of the fixed-length code, the attributes corresponding to each position coordinates of the 3D data point set package can be decoded.

In some embodiments, the depth of the fixed-length code may be determined based on a to-be-encoded 3D data point set.

More specifically, the bit depth of the fixed-length code may be determined based on the maximum value of the attribute of the 3D data point in the to-be-encoded 3D data point set and/or the value distribution of the attribute of the one or more 3D data points.

In some embodiments, the encoding end may determine the number of bits occupied by the maximum value of the attribute of the to-be-encoded 3D data point set as the depth of the fixed-length code.

For example, the maximum value of the attribute of a 3D data point may be 20 (decimal), then 5 bits may be needed when the value is generated as a binary string, and the depth of the fixed-length code may be 5. If the value of some attributes is less than 20, the corresponding binary string may actually occupy less than 5 bits. In this case, a zero can be added to the high bit to make the number of occupied bits reach 5.

In some embodiments, the encoder may determine the depth of the fixed-length code based on the value distribution of the attributes of the 3D data points. More specifically, if the value of the attribute is mostly less than or equal to a certain value, the number of bits occupied by the binary string corresponding to the value may be determined as the depth of the fixed-length code. Attributes with a value greater than this value may be encoded based on this value.

For example, if there are 80% of the attributes whose value is less than 20 (decimal), then 5 bits may be needed to generate the value as a binary string, and the depth of the fixed-length code may be 5. If the value of some attributes is less than 20, the corresponding binary string may actually occupy less than 5 bits. In this case, a zero can be added to the high bit to make the number of occupied bits reach 5. If the value of some attributes is greater than 20, the actual number of bits occupied by the corresponding binary string may be greater than 5 bits, and the value of the attribute may be revised to 20, that is, the number of bits occupied can be unified to 5 bits.

In some embodiments, the encoding end may determine the depth of the fixed-length code based on the maximum value of the attribute of the to-be-encoded 3D data point and the value distribution of the attribute of the 3D data point. More specifically, if the value of the attribute is mostly less than or equal to a certain value, and the difference between the value and the maximum value is less than or equal to a certain value, then the number of bits occupied by the binary string corresponding to the value may be determined as the depth of the fixed-length code, and attributes greater than the value may be encoded based on the value.

For example, if there are 80% of the attributes whose value is less than 20 (decimal) and the difference between 20 and the maximum value of 25 is less than or equal to 10, then the depth of the fixed-length code may be 5. If the value of some attributes is less than 20, the corresponding binary string may actually occupy less than 5 bits. In this case, a zero can be added to the high bit to make the number of occupied bits reach 5 If the value of some attributes is greater than 20, the actual number of bits occupied by the corresponding binary string may be greater than 5 bits, and the value of the attribute may be revised to 20, that is, the number of bits occupied can be unified to 5 bits.

In some embodiments, the encoding end may also determine the bit depth of the fixed-length code based on the hardware processing capability of the data acquisition device of the 3D data point set when it is working.

More specifically, when the data acquisition device of the 3D data point set is working, the hardware processing capability may determine the depth of the fixed-length code, and the encoding end may determine the depth of the fixed-length code based on it. For example, of the hardware processing capability determines the maximum value of the attribute, the hardware processing capability may indicate the depth corresponding to the maximum value.

In some embodiments, the depth of the fixed-length code may also be preset at the encoding end. At this time, the encoding end may use the preset depth of the fixed-length code to encode the attributes without considering the characteristics of the coded bitstream. At this time, the depth of the fixed-length code may also be preset at the decoding end, and the encoding end may not need to write the depth of the fixed-length code in the bitstream.

The above describes the process of using the fixed-length code encoding method for encoding. The following will introduce the process of using the truncated Rice encoding method for encoding.

The truncated Rice encoding method may include parameters such as the threshold value cMax, the Rice parameter R, and the attribute value Ref. The truncated Rice code can be formed by concatenating a prefix code P and a suffix code S. The prefix code can be calculated as follow:

p=Re f>>R Formula 1

If P is less than (cMax>>R), the prefix code may be composed of P 1s and a 0, and the length may be P+1. If P is greater than or equal to (cMax>>R), the prefix code may be composed of (cMax>>R) 1s, and the length may be (cMax>>R).

When the attribute value Ref is less than cMax, the suffix value S may be calculated as follow:

S=Re f−(p<<R) Formula 2

In some embodiments, the suffix code S may be a binary string with a length of R. When the value of R is greater than or equal to cMax, there may be no suffix code.

After obtaining the truncated Rice code at the encoding end, the truncated Rice code can be sent to an arithmetic coding engine in the order of position coordinates encoding for arithmetic encoding, and a compressed and encoded bitstream can be obtained at the end. After obtaining the to-be-decoded bitstream, the decoding end can decode the to-be-decoded bitstream based on the threshold value cMax and the Rice parameter R.

In some embodiments, the parameter threshold cMax and the Rice parameter R used for truncated Rice encoding may be determined by the hardware processing capability of the data acquisition device based on the 3D data point set at the encoding end, the maximum value of the attribute to be encoded, and/or the distribution interval of the attribute value, or it may be determined based on other parameters.

In some embodiments, when encoding the 3D data point set based on the 3D data point set package, all 3D data point set packages may have the same parameter threshold value cMax and/or Rice parameter R, or different 3D data point sets may have different parameter threshold values cMax and/or Rice parameters R.

In some embodiments, the above threshold value cMax and Rice parameter R may be written into the bitstream. More specifically, the threshold value cMax and Rice parameter R can be written into the header information of the bitstream, such that the decoding end can decode based on the cMax and the Rice parameter R. Of course, one of these two parameters may also be written in the bitstream, and the other parameter may be preset at the decoding end; or both parameters may be preset at the decoding end.

The fixed-length code encoding method and the truncated Rice encoding method are described above. The following describes the Kth order exponential Golomb encoding method.

In some embodiments, the Kth order exponential Golomb encoding method may include the following processes.

First, write a number N in binary form, remove the lowest k bits, and add one.

Second, calculate the number of bits left and subtract one from this number, which is the number of prefix zeros that need to be added.

Third, add the lowest k bits removed in the first process to the end of the bit string to obtain the Kth order exponential Golomb code.

The following takes the attribute as reflectance, the attribute value as 4, and the value of k as 1 as an example.

First, the binary representation of 4 is 100. After removing the lowest bit 0 and adding 1, the binary representation becomes 11.

Second, the number of bits of 11 is 2, such that the number of 0s in the prefix is 1.

Third, the lowest bit 0 of the bit string that was removed earlier is added back, and the final codeword becomes 0110, that is, the first-order exponential Golomb is obtained.

For the Kth order exponential Golomb code, the prefix may be composed of m consecutive 0s and one 1, and the suffix may be composed of m+k, which is the binary representation of N−2^{k}(2^{m}−1). In this way, the binarization of the value of the attribute can be realized to obtain a binary bitstream. Subsequently, the encoding end may send the binary bitstream to the entropy encoding engine in the order of position coordinates encoding for arithmetic encoding, and the compressed coded bitstream can be obtained at the end.

For the decoding end, the decoding end may decode the Kth order Golomb code storing the attribute information based on the position order after the position coordinates is decoded. When analyzing the Kth order exponential Golomb code, first look for the first non-zero bit from the current position of the bitstream, and record the number of zero bits found as m, and the decimal value of the m+k binary bit string after the first non-zero bit may be the value. The calculated decoded value codeNum may be calculated as follow.

codeNum=2^{m+k}−2^{k}+value Formula 3

By decoding the Kth order exponential Golomb code, the attribute information corresponding to the reconstructed position coordinates can be obtained. Based on this process, the data of the 3D data point set can be decoded.

In some embodiments, the value of k may be written into the bitstream. More specifically, the value of k can be written into the header information of the bitstream, such that the decoding end can decode based on value of k. Of course, the value of k may also be preset at the decoding end. In this case, the encoding end may not need to write the value of k into the bitstream.

In some embodiments, the value of k used for the Kth order exponential Golomb encoding may be determined by the hardware processing capability of the data acquisition device based on the 3D data point set at the encoding end, the maximum value of the attribute to be encoded, and/or the distribution interval of the attribute value, or it may be determined based on other parameters.

In some embodiments, when encoding the 3D data point set based on the 3D data point set package, all 3D data point set packages may have the same value of k, or different 3D data point sets may have different values of k.

The above respectively introduced the fixed-length code encoding method, the truncated Rice encoding method, and the Kth order exponential Golomb encoding method. However, it should be understood that the binary encoding in the embodiments of the present disclosure may also adopt other encoding methods, which is not limited in the embodiments of the present disclosure.

The attribute encoding has been described above, and the position coordinate encoding will be described below.

The position coordinate encoding in the embodiments of the present disclosure may adopt the octree encoding method. In the octree encoding process, the largest cube of the octree can be initialized. Based on the largest cube, the octree can be divided recursively. In some embodiments, the octree division may include using the position coordinates of the center point of the current block of the current layer to divide into eight sub-blocks; determining whether there are 3D data points in each sub-block, and further dividing the sub-blocks with the 3D data points until the side length of the sub-block is less than or equal to a preset value; and generating a first binary bitstream based on the situation that each block of each layer including the 3D data points. In some embodiments, the side length of the largest cube may be an integer power of 2, and may be the closest to the integer power of 2 that is greater than or equal to a first value, where the first value may be the maximum value of three maximum values, and the three maximum values may be respectively the maximum values of the position coordinates of all 3D data points in the 3D data point set on three axes.

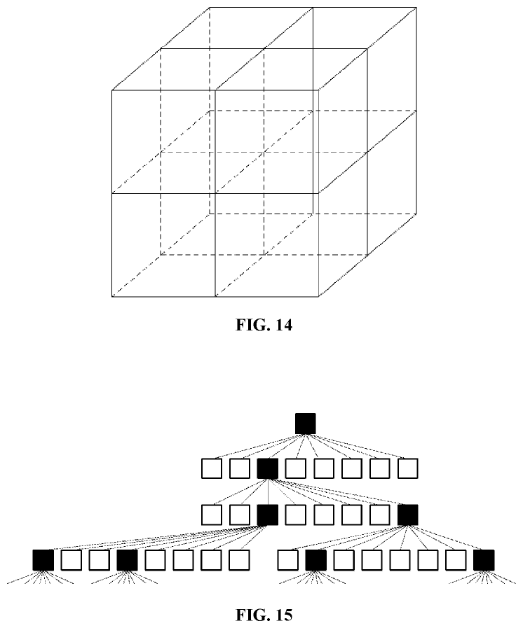

More specifically, for the compression of the position coordinates of the 3D data point set, the position coordinates may be first quantified, that is, the position coordinates may be converted into integer coordinates greater than or equal to zero. Then whether to remove duplicate coordinates can be determined. If there is no need to remove duplicate coordinates, octree encoding can be directly performed. If there is a need to remove duplicate coordinates, the duplicate coordinates can be removed first, then octree encoding can be performed. The octree encoding may be a method of compressing coordinate positions by using octree division. The division of each layer of the octree may use the coordinates of the center point of the current block to divide the current block into eight small sub-blocks through the center point, as shown in FIG. 14. After obtaining the sub-blocks, whether there are 3D data points in each sub-block can be determined, and the sub-blocks with the 3D data points may be further divided until the sub-block is divided to the minimum, that is, the side length of the sub-block is 1. FIG. 15 is a schematic diagram of the recursive division of the octree.

For the decoding end, the largest cube block of the octree can be initialized, and based on the size of the largest cube block, the first binary bitstream can be decode byte by byte. The decoding may include determining whether to further divide the current block based on the value of each bit in the current byte and the size of the current block, if the value of the bit is 1, then the current block is further divided into sub-blocks until the side length of the sub-block is less than or equal to the preset value; and determining the position coordinates of the 3D data point based on the sub-block whose side length is less than or equal to the preset value and the corresponding bit value is 1.

More specifically, one byte includes eight bits, and the value of the eight bits can indicate whether the corresponding sub-block needs to be further divided. If the value of the bit is 1, then the corresponding sub-blocks needs to be divided until the side length of a sub-block is 1, thereby determining the position coordinates of the 3D data point based on the side length equal to 1 and the corresponding bit value of 1.

In some embodiments, the bitstream may also store the number of 3D data points corresponding to each block with a side length of 1. These numbers can be decoded to identify the number of 3D data points corresponding to a quantized position coordinate. In addition, the bitstream of the attributes may be continuous. Each attribute may be decoded in sequence, and the correspondence between the position coordinates and attributes can be realized by corresponding the sequence with the sequence of the previous 3D data points.

In some embodiments, the 3D data point described above may be any point cloud point in the point cloud data obtained by a distance measuring device. In some embodiments, the distance measuring device may be an electronic device such as a lidar and a laser distance measuring device. In some embodiments, the distance measuring device can be used to sense external environmental information, such as distance information, orientation information, reflection intensity information, speed information, etc. of targets in the environment. A point cloud point may include at least one of the external environment information measured by the distance measuring device. In some embodiments, when the distance measuring device obtains a certain number of 3D data points, a data packet can be generated based on the certain number of 3D data points. The encoding/decoding method for 3D data point set provided in the embodiments of the present disclosure can be applied to encode/decode 3D data points in the data packet.

In some embodiments, the distance measuring device can detect the distance from a detection object to the distance measuring device by measuring the time of light propagation between the distance measuring device and the detection object, that is, the time-of-flight (TOF). Alternative, the distance measuring device can also detect the distance from the detection object to the distance measuring device through other methods, such as the distance measuring method based on phase shift measurement, or the distance measuring method based on frequency shift measurement, which is not limited in the embodiments of the present disclosure.

In some embodiments, the scanning trajectory of the distance measuring device may change over time. In this way, as the scanning time accumulates, the 3D data points scanned by the distance measuring device in the field of view may be distributed more and more densely in the field of view.

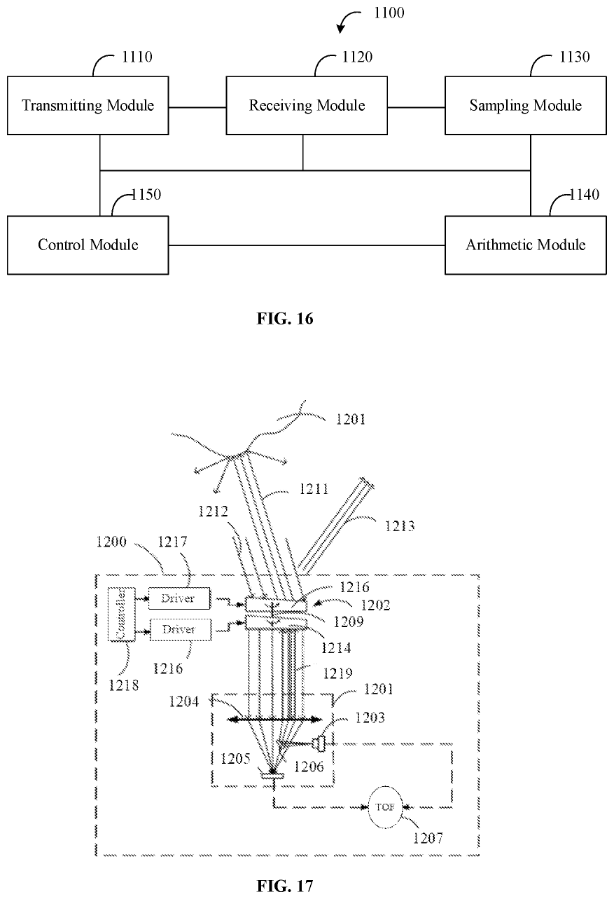

For ease of understanding, the working process of distance measurement will be described below in conjunction with a distance measuring device 1100 shown in FIG. 16.

As shown in FIG. 16, the distance measuring device 1100 includes a transmitting circuit 1110, a receiving circuit 1120, a sampling circuit 1130, and an arithmetic circuit 1140.

The transmitting circuit 1110 may emit a light pulse sequence (e.g., a laser pulse sequence). The receiving circuit 1120 can receive the light pulse sequence reflected by the object to be detected, and perform photoelectric conversion on the light pulse sequence to obtain an electrical signal, and then the electrical signal can be processed and output to the sampling circuit 1130. The sampling circuit 1130 can sample the electrical signal to obtain a sampling result. The arithmetic circuit 1140 can determine the distance between the distance measuring device 1100 and the object to be detected based on the sampling result of the sampling circuit 1130.

In some embodiments, the distance measuring device 1100 may further include a control circuit 1150. The control circuit 1150 can control other circuits, such as control the working time of each circuit and/or set parameters for each circuit, etc.

It should be understood that although the distance measuring device shown in FIG. 16 includes a transmitting circuit, a receiving circuit, a sampling circuit, and an arithmetic circuit to emit a light beam for detection, however, the embodiments of the present disclosure are not limited thereto. The number of any one of the transmitting circuit, the receiving circuit, the sampling circuit, and the arithmetic circuit may also be at least two, which can be used to emit at least two light beams in the same direction or different directions. In some embodiments, the at least two light beams may be emitted at the same time or at different times. In one example, the light emitting chips in the at least two emitting circuits may be packaged in the same module. For example, each transmitting circuit may include a laser transmitting chip, and the dies in the laser transmitting chips in the at least two transmitting circuits may be packaged together and housed in the same packaging space.

In some implementations, in addition to the circuit shown in FIG. 16, the distance measuring device 1100 may further include a scanning module 1160, which can be used to change the propagation direction of at least one laser pulse sequence emitted by the transmitting circuit and emit it.

In some embodiments, a module including the transmitting circuit 1110, the receiving circuit 1120, the sampling circuit 1130, and the arithmetic circuit 1140, or a module including the transmitting circuit 1110, receiving circuit 1120, sampling circuit 1130, arithmetic circuit 1140, and control circuit 1150 may be referred to as a distance measuring module. The distance measuring module 1150 may be independent of other modules, such as the scanning module 1160.

A coaxial light path may be used in the distance measuring device, that is, the light beam emitted by the distance measuring device and the reflected light beam can share at least a part of the light path in the distance measuring device. For example, after at least one laser pulse sequence emitted by the transmitting circuit changes its propagation direction through the scanning module and exits, the laser pulse sequence reflected by the object to be detected may pass through the scanning module and enter the receiving circuit. Alternatively, the distance measuring device may also adopt an off-axis light path, that is, the light beam emitted by the distance measuring device and the reflected light beam may be respectively transmitted along different light paths in the distance measuring device. FIG. 17 is a schematic diagram of a light detection device using a coaxial light path according to an embodiment of the present disclosure.

A distance measuring device 1200 includes a distance measuring module 1210. The distance measuring module 1210 includes a transmitter 1203 (including the transmitting circuit described above), a collimating element 1204, a detector 1205 (which may include the receiving circuit, sampling circuit, and arithmetic circuit described above), and a light path changing element 1206. The distance measuring module 1210 may be used to transmit the light beam, receive the returned light, and convert the returned light into an electrical signal. In some embodiments, the transmitter 1203 may be used to emit a light pulse sequence. In one embodiment, the transmitter 1203 may emit a sequence of laser pulses. In some embodiments, the laser beam emitted by the transmitter 1203 may be a narrow-bandwidth light beam with a wavelength outside the visible light range. The collimating element 1204 may be disposed on an exit light path of the transmitter and used to collimate the light beam emitted from the transmitter 1203 and collimate the light beam emitted from the transmitter 1203 into parallel light and output to the scanning module. The collimating element may also be used to condense at least a part of the returned light reflected by the object to be detected. The collimating element 304 may be a collimating lens or other elements capable of collimating light beams.

In the embodiment shown in FIG. 17, by using the light path changing element 1206 to combine the transmitting light path and the receiving light path in the distance measuring device before the collimating element 1204, the transmitting light path and the receiving light path can share the same collimating element, making the light path more compact. In some other implementations, the transmitter 1203 and the detector 1205 may also use their respective collimating elements, and the light path changing element 1206 may be disposed on the light path behind the collimating element.

In the embodiment shown in FIG. 17, since the beam aperture of the light beam emitted by the transmitter 1203 is relatively small, and the beam aperture of the returned light received by the distance measuring device is relatively large, the light path changing element may use a small-area mirror to combine the emitting light path and the receiving light path. In some other implementations, the light path changing element may also adopt a reflector with a through hole, where the through hole may be used to transmit the emitted light of the transmitter 1203, and the reflector may be used to reflect the returned light to the detector 1205. In this way, it is possible to reduce the blocking of the returned light by the support of the small reflector when the small reflector is used.

In the embodiment shown in FIG. 17, the light path changing element may deviate from the optical axis of the collimating element 1204. In some other implementations, the light path changing element may also be positioned on the optical axis of the collimating element 1204.

The distance measuring device 1200 may further include a scanning module 1202. The scanning module 1202 may be disposed on the exit light path of the distance measuring module 1210. The scanning module 1202 may be used to change the transmission direction of a collimated light beam 1219 emitted by the collimating element 1204, and project the returned light to the collimating element 1204. The returned light may be collected on the detector 1205 via the collimating element 1204.

In one embodiment, the scanning module 1202 may include at least one optical element for changing the propagation path of the light beam, where the optical element may change the propagation path of the light beam by reflecting, refracting, or diffracting the light beam. For example, the scanning module 1202 may include a lens, a mirror, a prism, a galvanometer, a grating, a liquid crystal, an optical phased array, or any combination of the foregoing optical elements. In one example, at least part of the optical element may be movable. For example, the at least part of the optical element may be driven by a driving module, and the movable optical element can reflect, refract, or diffract the light beam to different directions at different times. In some embodiments, a plurality of optical elements of the scanning module 1202 may rotate around a common axis 1209, and each rotating or vibrating optical element may be used to continuously change the propagation direction of the incident light beam. In one embodiment, the plurality of optical elements of the scanning module 1202 may rotate at different rotation speeds or vibrate at different speeds. In another embodiment, the plurality of optical elements of the scanning module 1202 may rotate at substantially the same rotation speed. In some embodiments, the plurality of optical elements of the scanning module 1202 may also rotate around different axes. In some embodiments, the plurality of optical elements of the scanning module 1202 may also rotate in the same direction or in different directions, or vibrate in the same direction or different directions, which is not limited herein.

In one embodiment, the scanning module 1202 may include a first optical element 1214 and a driver 1216 connected to the first optical element 1214. The driver 1216 may be used to drive the first optical element 1214 to rotate around the rotation axis 1209, such that the first optical element 1214 can change the direction of the collimated light beam 1219. The first optical element 1214 may project the collimated light beam 1219 to different directions. In one embodiment, an angle between the direction of the collimated light beam 1219 changed by the first optical element and the rotation axis 309 may change with the rotation of the first optical element 1214. In one embodiment, the first optical element 1214 may include a pair of opposite non-parallel surfaces, and the collimated light beam 1219 may pass through the pair of surfaces. In one embodiment, the first optical element 1214 may include a prism whose thickness may vary in at least one radial direction. In one embodiment, the first optical element 1214 may include a wedge-angle prism to collimate the beam 1219 for refracting.

In one embodiment, the scanning module 1202 may further include a second optical element 1215. The second optical element 1215 may rotate around the rotation axis 1209, and the rotation speed of the second optical element 1215 may be different from the rotation speed of the first optical element 1214. The second optical element 1215 may be used to change the direction of the light beam projected by the first optical element 1214. In one embodiment, the second optical element 1215 may be connected to another driver 1217, and the driver 1217 may drive the second optical element 1215 to rotate. The first optical element 1214 and the second optical element 1215 may be driven by the same or different drivers, such that the first optical element 1214 and the second optical element 1215 may have different rotation speeds and/or steering directions, such that the collimated light beam 1219 may be projected to different directions in the external space to scan a larger spatial range. In one embodiment, a controller 1218 may control the driver 1216 and driver 1217 to drive the first optical element 1214 and the second optical element 1215, respectively. The rotation speeds of the first optical element 1214 and the second optical element 1215 may be determined based on the area and pattern expected to be scanned in actual applications. The drivers 1216 and 1217 may include motors or other driving devices.

In some embodiments, the second optical element 1215 may include a pair of opposite non-parallel surfaces, and a light beam may pass through the pair of surfaces. In one embodiment, the second optical element 1215 may include a prism whose thickness may vary in at least one radial direction. In one embodiment, the second optical element 1215 may include a wedge-prism.

In one embodiment, the scanning module 1202 may further include a third optical element (not shown in the drawings) and a driver for driving the third optical element to move. In some embodiments, the third optical element may include a pair of opposite non-parallel surfaces, and a light beam may pass through the pair of surfaces. In one embodiment, the third optical element may include a prism whose thickness may vary in at least one radial direction. In one embodiment, the third optical element may include a wedge-prism. At least two of the first, second, and third optical elements may rotate at different rotation speeds and/or rotation directions.

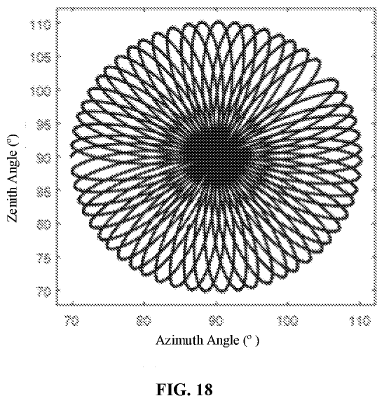

The rotation of each optical element in the scanning module 1202 may project light to different directions, such as light directions 1211 and 1213, such that the space around the distance measuring device 1200 can be scanned. As shown in FIG. 18, which is a schematic diagram of a scanning pattern of the distance measuring device 1200. It can be understood that when the speed of the optical element in the scanning module changes, the scanning pattern will also change accordingly.

When the light 1211 projected by the scanning module 1202 hits an object to be detected 1201, a part of the light may be reflected by the object to be detected 1201 to the distance measuring device 1200 in a direction opposite to the projected light 1211. The returned light 1212 reflected by the object to be detected 1201 may incident on the collimating element 1204 after passing through the scanning module 1202.

The detector 1205 and the transmitter 1203 may be placed on the same side of the collimating element 1204, and the detector 1205 may be used to convert at least part of the returned light passing through the collimating element 1204 into electrical signals.

In some embodiments, each optical element may be coated with an anti-reflection coating. In some embodiments, the thickness of the anti-reflection coating may be equal to or close to the wavelength of the light beam emitted by the transmitter 1203, which can increase the intensity of the transmitted light beam.

In one embodiment, a filtering layer may be plated on the surface of an element positioned on the light beam propagation path in the distance measuring device, or a filter may be disposed on the light beam propagation path for transmitting at least the wavelength band of the light beam emitted by the transmitter, and reflect other wavelength bands to reduce the noise caused by ambient light to the receiver.

In some embodiments, the transmitter 1203 may include a laser diode, and nanosecond laser pulses may be emitted through the laser diode. Further, the laser pulse receiving time may be determined, for example, by detecting the rising edge time and/or falling edge time of the electrical signal pulse to determine the laser pulse receiving time. In this way, the distance measuring device 1200 may calculate the TOF using the pulse receiving time information and the laser pulse sending time information, thereby determining the distance from the object to be detected 1201 to the distance measuring device 1200.

The distance and orientation detected by the distance measuring device 1200 may be used for remote sensing, obstacle avoidance, surveying and mapping, navigation, and the like. In one embodiment, the distance measuring device provided in the embodiments of the present disclosure can be applied to a movable platform, and the distance measuring device can be mounted on the platform body of the movable platform. The movable platform including the distance measuring device can measure the external environment, such as measuring the distance between the movable platform and obstacles for obstacle avoidance and other purposes, and for two-dimensional or three-dimensional mapping of the external environment. In some embodiments, the movable platform may include at least one of an unmanned aerial vehicle (UAV), a vehicle, a remote-controlled vehicle, a robot, and a camera. When the distance measuring device is applied to a UAV, the platform body may be the body of the UAV. When the distance measuring device is applied to a vehicle, the platform body may be the body of the vehicle. The vehicle may be a self-driving vehicle or a semi-self-driving vehicle, which is not limited here. When the distance measuring device is applied to a remote-controlled vehicle, the platform body may be the body of the remote-controlled vehicle. When the distance measuring device is applied to a robot, the platform body may be the robot. When the distance measuring device is applied to a camera, the platform body may be the camera itself.

The foregoing describes the method for encoding and decoding a 3D data point set provided in the embodiments of the present disclosure, and the following will describe a device for encoding and decoding a 3D data point set.

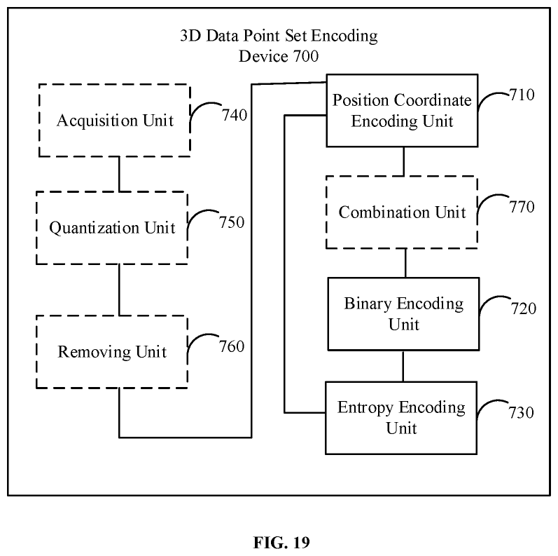

FIG. 19 is a block diagram of a 3D data point set encoding device 700 according to an embodiment of the present disclosure. The device 700 includes a position coordinate encoding unit 710 configured to perform position coordinate encoding on position coordinates of one or more 3D data points in the 3D data point set to obtain a first binary bitstream; a binary encoding unit 720 configured to perform binary encoding on the attributes of the one or more 3D data points based on the position coordinates order after the encoding of the position coordinates of the one or more 3D data points to obtain a second binary bitstream; and a entropy encoding unit 730 configured to respectively perform entropy encoding on the first binary bitstream and the second binary bitstream.

In some embodiments, as shown in FIG. 19, the device 700 further includes an acquisition unit 740 configured to acquire a target 3D data point set package before the position coordinate encoding unit performs position coordinate encoding, where the 3D data point set may be included in the target 3D data point set package.

In some embodiments, the acquisition unit 740 may be configured to determine the package consisting the acquired 3D data points as the target 3D data point set package when the number of the 3D data points obtained from the transmitted original 3D data point set data stream reaches a preset value.

In some embodiments, the attribute may include one component.

In some embodiments, the attribute may be used to characterize the reflectance at the position coordinates position coordinates in the 3D data point set.

In some embodiments, the binary encoding unit 720 may be further configured to perform binary encoding on the attributes of one or more 3D data points by using a fixed-length code encoding method, a truncated Rice encoding method, or a Kth order exponential Golomb encoding method.

In some embodiments, the binary encoding unit 720 may be further configured to determine the bit depth of the fixed-length code based on the maximum value of the attributes of the one or more 3D data points and/or the value distribution of the attribute of the one or more 3D data points; and, binarize the attributes of the one or more 3D data points based on the bit depth of the fixed-length code.

In some embodiments, the binary encoding unit 720 may be further configured to determine the bit depth of the fixed-length code indicated by the hardware processing capability of the 3D data point set data acquisition device when working; and, binarize the attributes of the one or more 3D data points based on the bit depth of the fixed-length code.

In some embodiments, the binary encoding unit 720 may be further configured to write the bit depth of the fixed-length code into the bitstream in response to binarizing the attributes of the one or more 3D data points by using the fixed-length code encoding method; or, write the threshold value of the truncated Rice and/or the Rice parameter of shifting into the bitstream in response to binarizing the attributes of the one or more 3D data points by using the truncated Rice encoding method; or, write the value of K into the bitstream in response to binarizing the attributes of the one or more 3D data points by using the Kth order exponential Golomb encoding method.

In some embodiments, the position coordinate encoding unit 710 may be further configured to perform octree encoding on the position coordinates of the one or more 3D data points.

In some embodiments, the position coordinate encoding unit 710 may be further configured to initial the largest cube of the octree; recursively dividing the octree based on the largest cube, the octree division including using the position coordinates of the center point of the current block of the current layer to divide into eight sub-blocks, determining whether there are 3D data points in each sub-block, and further dividing the sub-blocks with the 3D data points until the side length of the sub-block is less than or equal to a preset value; and generating a first binary bitstream based on the situation that each block of each layer including the 3D data points.

In some embodiments, the side length of the largest cube may be an integer power of 2, and may be the closest to the integer power of 2 that is greater than or equal to a first value, where the first value may be the maximum value of three maximum values, and the three maximum values may be respectively the maximum values of the position coordinates of all 3D data points in the 3D data point set on three axes.

In some embodiments, as shown in FIG. 19, the device 700 further includes a quantization unit 750 configured to quantify the position coordinates of the one or more 3D data points.

In some embodiments, as shown in FIG. 19, the device 700 further includes a removing unit 760 configured to remove duplicate position coordinates from the quantized position coordinates.

In some embodiments, the removing unit 760 may be further configured to remove the duplicated position coordinates from the quantized position coordinates in response to determining that the duplicate position coordinates need to be remove based on the encoding condition.

In some embodiments, as shown in FIG. 19, the device 700 further includes a combination unit 770 configured to combine at least two attributes if after quantifying the position coordinates of the one or more 3D data points and removing duplicate position coordinates, the first position coordinates therein correspond to at least two attributes.

In some embodiments, the position coordinate encoding unit 710 may be further configured to write the number of attributes corresponding to each position coordinates in the bitstream if the duplicate position coordinates are not removed after quantizing the position coordinates of the one or more 3D data points.

It should be understood that the device 700 can be used to implement the corresponding operations implemented by the encoding end in the foregoing method. For brevity, details will not be repeated here.

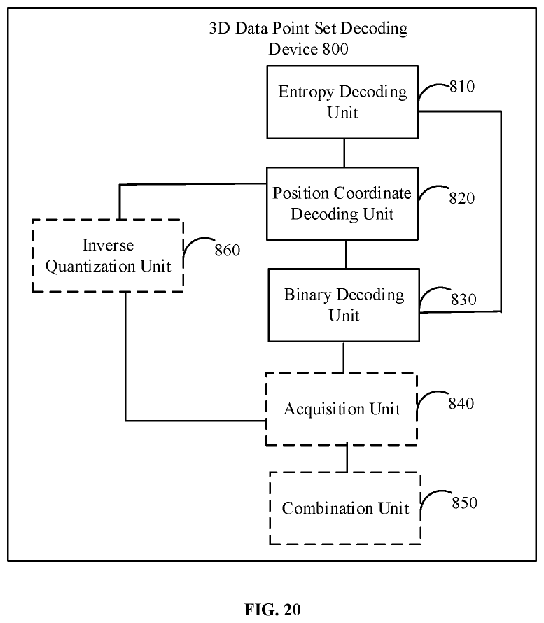

FIG. 20 is a block diagram of a 3D data point set decoding device 800 for decoding a 3D data point set according to an embodiment of the present disclosure. The device 800 includes an entropy decoding unit 810 configured to perform entropy decoding on a to-be-decoded bitstream of the 3D data point set to obtain a first binary bitstream and a second binary bitstream; a position coordinate decoding unit 820 configured to decode the position coordinates of the first binary bitstream to obtain the position coordinates of one or more 3D data points in the 3D data point set; and a binary decoding unit 830 configured to perform binary decoding on the second binary bitstream based on the decoded position coordinates sequence of the one or more 3D data points to obtain the attributes of the one or more 3D data points.

In some embodiments, as shown in FIG. 20, the device 800 further includes an acquisition unit 840 configured to acquire a target 3D data point set package based on the position coordinates of the one or more 3D data points and the attributes of the one or more 3D data points, the 3D data point set being included in the target 3D data point set package.

In some embodiments, as shown in FIG. 20, the device 800 further includes a combination unit 850 configured to combine the acquired multiple target 3D data point set packages to obtain a reconstructed 3D data point set data.

In some embodiments, the attribute may include one component.

In some embodiments, the attribute may be used to characterize the reflectance at the position coordinates position coordinates in the 3D data point set.

In some embodiments, the binary decoding unit 830 may be further configured to perform binary decoding on the attributes of one or more 3D data points by using a fixed-length code decoding method, a truncated Rice decoding method, or a Kth order exponential Golomb decoding method.

In some embodiments, the binary decoding unit 830 may be further configured to determine the bit depth of the fixed-length code indicated by the hardware processing capability of the 3D data point set data acquisition device when working; and, perform binary decoding on the second binary bitstream based on the bit depth of the fixed-length code.

In some embodiments, the binary decoding unit 830 may be further configured to obtain the bit depth of the fixed-length code from the to-be-decoded bitstream in response to performing binary decoding on the second binary bitstream by using the fixed-length code encoding method; or, obtain the threshold value of the truncated Rice and/or the Rice parameter of shifting from the to-be-decoded bitstream in response to performing binary decoding on the second binary bitstream by using the truncated Rice encoding method; or, obtain the value of K from the to-be-decoded bitstream in response to performing binary decoding on the second binary bitstream by using the Kth order exponential Golomb encoding method

In some embodiments, the position coordinate decoding unit 820 may be further configured to perform octree decoding on the first binary bitstream.

In some embodiments, the position coordinate decoding unit 820 may be further configured to initialize the largest cube of the octree; decode the first binary bitstream byte by byte based on the size of the largest cube block, the decoding including determining whether to further divide the current block based on the value of each bit in the current byte and the size of the current block, if the value of the bit is 1, then the current block is further divided into sub-blocks until the side length of the sub-block is less than or equal to the preset value; and determining the position coordinates of the 3D data point based on the sub-block whose side length is less than or equal to the preset value and the corresponding bit value is 1.

In some embodiments, the binary decoding unit 830 may be further configured to obtain the number of attributes corresponding to a single position coordinate from the bitstream; and, perform binary decoding on the attributes corresponding to the single position coordinate based on the number.

In some embodiments, as shown in FIG. 20, the device 800 further includes an inverse quantization unit 860 configured to perform inverse quantization on the decoded position coordinates.

It should be understood that the device 800 can be used to implement the corresponding operations implemented by the decoding end in the foregoing method. For brevity, details will not be repeated here.

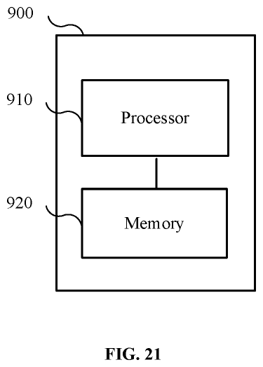

FIG. 21 is a block diagram of a computer system 900 according to an embodiment of the present disclosure. As shown in FIG. 21, the computer system 900 includes a processor 510 and a memory 520.

It should be understood that the computer system 900 may also include components commonly included in other computer systems, such as input and output devices, communication interfaces, etc., which is not limited in the embodiments of the present disclosure.

The memory 920 is configured to store computer-executable instructions.

The memory 920 may be various types of memory, for example, it may include a high-speed random-access memory (RAM), and may also include a non-volatile memory such as at least one disk memory, which is not limited by the embodiments of the present disclosure.

The processor 910 is configured to access the memory 920 and execute the computer-executable instructions to perform operations in the method for encoding or decoding a 3D data point set according to various embodiments of the present disclosure.

The processor 910 may include a microprocessor, a field-programmable gate array (FPGA), a central processing unit (CPU), a graphics processing unit (GPU), etc., which is not limited by the embodiments of the present disclosure.

The device and computer system for encoding or decoding a 3D data point set described in the embodiments of the present disclosure may correspond to the execution body of the method for encoding or decoding a 3D data point set described in the embodiments of the present disclosure, and can be used for the above-mentioned and other operations and/or functions of each module in the device and computer system for encoding or decoding the 3D data point set, respectively, in order to realize the corresponding procedures of the aforementioned various methods. For brevity, details will not be repeated here.

An embodiment of the present disclosure further provides an electronic device. The electronic device may include the device or computer system for encoding or decoding a 3D data point set of the various embodiments of the present disclosure described above.

An embodiment of the present disclosure further provides a computer storage medium. The computer storage medium stores program code, and the program code may be configured to perform the method for encoding or decoding a 3D data point set described in foregoing embodiments of the present disclosure.

It should be understood that, in the embodiments of the present disclosure, the term “and/or” is merely a relationship describing a related object, indicating that there may be three relationships. For example, A and/or B indicates three cases, A alone, A and B, and B alone. In addition, the character “/” in this text generally indicates that the related objects are in an alternative (“or”) relationship.

Those of ordinary skill in the art may realize that the units and algorithm steps of each example described in connection with the embodiments disclosed herein can be implemented by electronic hardware, computer software, or a combination of the two. In order to clearly illustrate the interchangeability between hardware and software, the composition and steps of each example have been described generally in terms of functions in the above description. Whether these functions are performed in hardware or software depends on the specific application and design constraints of the technical solution. A person skilled in the art can use different methods to implement the described functions for each specific application, but such implementation should not be considered to be beyond the scope of the present disclosure.

Those skilled in the art can clearly understand that, for the convenience and brevity of description, the specific operating processes of the system, apparatus, and units described above can be referred to the corresponding processes in the foregoing method embodiments, and are not described herein again.

In the several embodiments provided in this application, it should be understood that the disclosed system, apparatus, and method may be implemented in other ways. For example, the apparatus embodiments described above are only schematic. For example, the division of the unit is only a logical function division. In actual implementation, there may be another division manner. For example, multiple units or components may be combined or can be integrated into another system, or some features can be ignored or not implemented. In addition, the displayed or discussed mutual coupling or direct coupling or connection may be indirect coupling or connection through some interfaces, devices, or units, or may be electrical, mechanical, or other forms of connection.

The units described as separate components may or may not be physically separated. The components displayed as units may or may not be physical units, may be located in one place, or may be distributed to multiple network units. Some or all of the units may be selected according to actual needs to achieve the objectives of the solutions of the embodiments of the present disclosure.

In addition, each functional unit in each embodiment of the present disclosure may be integrated into one processing unit, or each unit may exist separately physically, or two or more units may be integrated into one unit. The above integrated unit may be implemented in the form of hardware or in the form of software functional unit.

When the integrated unit is implemented in the form of a software functional unit and sold or used as an independent product, it may be stored in a computer-readable storage medium. Based on this understanding, the technical solution of the present disclosure is essentially a part that contributes to the existing technology, or all or part of the technical solution may be embodied in the form of a software product, which is stored in a storage medium, including some instructions for causing a computer device (which may be a personal computer, a server, or a network device, etc.) to perform all or part of the steps of the method described in the embodiments of the present disclosure. The foregoing storage medium includes flash drive, mobile hard disks, read-only memory (ROM), random-access memory (RAM), magnetic disks, or optical disks and other medium that can store program codes.

The above description is only specific embodiments of the present disclosure, but the protected scope of the present disclosure is not limited to this. Any person skilled in the art can easily think of various kinds of equivalent modifications or substitutions within the technical scope disclosed by the present disclosure. The modifications or substitutions should be covered by the protected scope of the present disclosure. Therefore, the protected scope of the present disclosure shall be in conformity with the protected scope of the appended claims.

What is claimed is:

1. A three-dimensional (3D) data point set encoding method, comprising:
performing position coordinate encoding on position coordinates of one or more 3D data points in the 3D data point set to obtain a first binary bitstream;
performing binary encoding on attributes of the one or more 3D data points based on a position coordinates sequence after encoding the position coordinates of the one or more 3D data points to obtain a second binary bitstream; and
performing entropy encoding on the first binary bitstream and the second binary bitstream respectively.

2. The method of claim 1, before performing position coordinate encoding on the position coordinates of the one or more 3D data points in the 3D data point set, further comprising:
obtaining a target 3D data point set package, the 3D data point set being included in the target 3D data point set package.

3. The method of claim 2, wherein obtaining the target 3D data point set package includes:
determining the package composed of obtained 3D data points as the target 3D data point set package when a number of 3D data points obtained from a transmitted original 3D data point set data stream reaches a preset value.

4. The method of claim 1, wherein:
the attribute is used to indicate a reflectance at a corresponding position coordinates in the 3D data point set.

5. The method of claim 1, wherein performing binary encoding on the attributes of one or more 3D data points includes:
performing binary encoding on the attributes of the one or more 3D data points by using a fixed-length code encoding method, a truncated Rice encoding method, or a Kth order exponential Golomb encoding method.

6. The method of claim 5, wherein performing binary encoding on the attributes of the one or more 3D data points by using the fixed-length code encoding method includes:
determining a bit depth of a fixed-length code based on a maximum value of the attributes of the one or more 3D data points and/or a value distribution of the attributes of the one or more 3D data points; and
performing binary encoding on the attributes of the one or more 3D data points based on the bit depth of the fixed-length code.

7. The method of claim 5, wherein performing binary encoding on the attributes of the one or more 3D data points by using the fixed-length code encoding method includes:
determining the bit depth of the fixed-length code indicated by a hardware processing capability of a 3D data point set data acquisition device when working; and
performing binary encoding on the attributes of the one or more 3D data points based on the bit depth of the fixed-length code.

8. The method of claim 5, further comprising:
writing the bit depth of the fixed-length code into a bitstream in response to performing binary encoding on the attributes of the one or more 3D data points by using the fixed-length code encoding method; or,
writing a threshold value of the truncated Rice and/or a Rice parameter for shifting into the bitstream in response to performing binary encoding on the attributes of the one or more 3D data points by using the truncated Rice encoding method; or,
writing a value of K into the bitstream in response to performing binary encoding on the attributes of the one or more 3D data points by using the Kth order exponential Golomb encoding method.

9. A 3D data point set decoding method, comprising:
performing entropy decoding on a to-be-decoded bitstream of the 3D data point set to obtain a first binary bitstream and a second binary bitstream;
performing position coordinate decoding on the first binary bitstream to obtain position coordinates of one or more 3D data points in the 3D data point set; and
performing binary decoding on the second binary bitstream based on a decoded position coordinates sequence of the one or more 3D data points to obtain attributes of the one or more 3D data points.

10. The method of claim 9, further comprising:
obtaining a target 3D data point set package based on the position coordinates of the one or more 3D data points and the attributes of the one or more 3D data points, the 3D data point set being included in the target 3D data point set package.

11. The method of claim 10, further comprising:
combining a plurality of obtained target 3D data point set packages to obtain reconstructed 3D data point set data.

12. The method of claim 9, wherein:
the attribute includes one component.

13. The method of claim 9, wherein:
the attribute is used to indicate a reflectance at a corresponding position coordinates in the 3D data point set.

14. The method of claim 9, wherein performing binary decoding on the second binary bitstream includes:
performing binary decoding on the second binary bitstream by using a fixed-length code encoding method, a truncated Rice decoding method, or a Kth order exponential Golomb decoding method.

15. The method of claim 14, wherein performing binary decoding on the second binary bitstream by using the fixed-length code decoding method includes:
determining a bit depth of a fixed-length code indicated by a hardware processing capability of a 3D data point set data acquisition device when working; and
performing binary decoding on the second binary bitstream based on the bit depth of the fixed-length code.

16. The method of claim 14, further comprising:
obtaining the bit depth of the fixed-length code from the to-be-decoded bitstream in response to the fixed-length code decoding method being used to perform binary decoding on the second binary bitstream; or,
obtaining a threshold value of the truncated Rice and/or a Rice parameter for shifting from the to-be-decoded bitstream in response to the truncated Rice decoding method being used to perform binary decoding on the second binary bitstream; or
obtaining a value of K from the to-be-decoded bitstream in response to the Kth order exponential Golomb decoding method being used to perform binary decoding on the second binary bitstream.

17. The method of claim 9, wherein performing position coordinate decoding on the first binary bitstream includes:
performing octree decoding on the first binary bitstream.

18. The method of claim 17, wherein performing octree decoding includes:
initializing a largest cube of the octree;
decoding the first binary bitstream byte by byte based on a size of the largest cube, the decoding including determining whether to further divide a current block based on a value of each bit in a current byte and the size of the current block, and further dividing the current block into a plurality of sub-blocks until a side length of the sub-block is less than or equal to a preset value if the bit value is 1; and
determining the position coordinates of the 3D data point based on the sub-block whose side length is less than or equal to the preset value and the corresponding bit value is 1.

19. The method of claim 9, wherein performing binary decoding on the second binary bitstream includes:
obtaining a number of attributes corresponding to a single position coordinate from the bitstream; and
performing binary decoding on the attributes corresponding to the single position coordinate based on the number of attributes.

20. The method of claim 9, after performing position coordinate decoding on the first binary bitstream, further comprising:
performing inverse quantization on the decoded position coordinates.
